(19) United States
(12) Patent Application Publication
(10) Pub. No.: US 2009/0188615 A1
(43) Pub. Date: Jul. 30, 2009

(54) METHOD FOR MANUFACTURING MULTILAYER OPTICAL RECORDING MEDIUM

(76) Inventors: Kazuhiro Hayashi, Okayama (JP); Kazuya Hisada, Osaka (JP); Yoshihiro Kawasaki, Osaka (JP); Keiji Nishikori, Kyoto (JP); Tsutomu Fujii, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/301,264

(22) PCT Filed: May 16, 2007
(86) PCT No.: PCT/JP2007/060014

§ 371 Date: Nov. 18, 2008

(30) Foreign Application Priority Data
May 18, 2006 (JP) 2006-138445

(51) Int. Cl. B32B 37/00

(52) U.S. Cl. 156/273.7

(57) ABSTRACT

The method for manufacturing a multilayer optical recording medium of the invention includes a plurality of signal recording layers in the signal recording and reading side, an interlayer of a resin layer between the signal recording layers, and a transparent protection layer with a thickness of 10 μm to 150 μm as an outermost layer. The multilayer optical recording medium has a clamp area corresponding to a region inside of the signal recording region, wherein the clamp area ranges in diameter from a diameter of 23 mm to the inner diameter of the signal recording region. The method includes: preparing a substrate having the signal recording layers in the main surface side in the signal recording and reading side and projections in a region in the inner side than a diameter of 22 mm, wherein the height difference between the height at a diameter of 23 mm and the height at a diameter of 21 mm is 20 μm or lower; preparing a stamper; applying a radiation-curable resin for the interlayer from the inner side than the clamp area of at least one of the substrate and the stamper; laminating the substrate and the stamper to sandwich the radiation-curable resin between the substrate and the stamper; curing the radiation-curable resin; and separating the stamper from the substrate to obtain a radiation-curable resin layer after the curing as the interlayer on the substrate.

### BACKGROUND OF THE INVENTION

1. Technical Field

The invention relates to a method for manufacturing a multilayer optical recording medium having a transparent protection layer with a thickness of 10 μm to 150 μm as an outermost layer in the signal recording and reading side, particularly to a method for manufacturing a multilayer optical recording medium, characterized in that in the case a layer for separating respective signal recording layers is defined as an interlayer, the interlayer is formed from the inner side of a diameter of 23 mm.

2. Background Art

As high density optical recording media are proposed a multilayer optical recording medium having a plurality of layers of signal recording faces in the thickness direction as in a single sided dual layer regenerable DVD. For example, a single-sided dual layer regenerable DVD has a configuration formed by respectively forming a light transmissive reflective layer made of gold, silicon or the like on a signal recording layer on one of two substrates and a conventional reflective layer made of aluminum or the like on a signal recording layer on the other substrate and sticking these substrates with each other with these signal recording layers facing inward.

In order to improve the in-plane recording density per layer, a blue-violet laser light source (having a wavelength of around 400 nm) and a high NA lens are used and a high density optical recording medium having a thin transparent protection layer with a thickness of 0.1 mm for example has practically been used. The high density optical recording medium has a configuration formed by forming guide grooves or pits for signals on the surface of a thick signal substrate, forming a re-writable multilayered recording film thereon, and further forming a transparent protection layer thereon. With respect to a high density optical information recording medium of this transparent protection layer type, those having two or more signal recording layers are supposed to be possible. The following method can be mentioned as one example of its manufacturing method.

(1) A thick substrate having guide grooves or pits of signals on the surface and bearing a re-writable multilayer recording film is made available.

(2) A separation layer is formed on the substrate using an ultraviolet-curable resin and guide grooves or pits for signals in a second layer are formed on the surface of the separation layer.

(3) A re-writable and light transmissive multilayer recording film is formed on the guide grooves or pits for signals in the second layer.

(4) A thin transparent protection layer with a thickness of 0.1 mm is formed.

As a specific manufacturing method, in Japanese Patent Laid-Open Publication No. 2003-203402, a stamper made of plastic is used for the above-mentioned step (2). After an ultraviolet-curable resin is applied to the signal guide grooves or pits on the stamper and cured, another ultraviolet-curing resin having different characteristics is stuck to the substrate on which the first multilayer recording film is formed. After the ultraviolet-curable resin is cured, the stamper is separated. If such a method is employed, a multilayer optical recording medium can be produced by using a thick substrate having rigidity as a base and layering one or a plurality of signal recording layers via separation layers on the base.

As a process for forming a transparent protection layer, there are methods, as disclosed in Japanese Patent Laid-open Publication No. 2002-184073 and International Patent Publication No. WO01/086648, a transparent film having thickness precision is stuck using an adhesive and the film and the adhesive are together formed to be a transparent protection layer. Further, as disclosed in Japanese Patent Laid-open Publication No. 2006-12412, there is a method in which a transparent ultraviolet-curable resin is applied to a second signal recording layer to use it as a transparent protection layer.

### SUMMARY OF THE INVENTION

However, in the case recording and reading are carried out using a multilayer optical recording medium with an about 0.1 mm-thick transparent protection layer and a high NA optical head with an NA of 0.7 to 0.9, e.g. an NA of 0.85 or the like, if the multilayer optical recording medium is warped, the medium is tilted relatively to the optical head. In this case, comatic aberration is generated in the laser light converged by the optical head and thus the convergence of a beam on the signal recording layer is deteriorated. Accordingly, qualities of signals recorded or regenerated are deteriorated and become poor in the stability. Further, even if the warp of the multilayer optical recording medium itself is slight, in the case the flatness of a clamp area of the optical recording medium is poor, at the time of holding the optical recording medium on a drive, the optical recording medium is substantially tilted to the optical head. In general, the region in the outside of a diameter of 23 mm of the optical recording medium is used as the clamp area. In the multilayer optical recording medium, particularly in the case of forming an interlayer for separating the signal recording layers, the flatness is sometimes deficient due to separation of the interlayer near the inner diameter (near 23 mm) of the clamp area. Therefore, including the transparent protection layer to be formed thereon, the clamp area tends to be deficient in the flatness.

In view of the above-mentioned state of the art, an object of the invention is to provide a multilayer optical recording medium excellent in flatness of the clamp area and capable of stably recording and regenerating signals at the time of recording and regenerating signals.

To establish the above-mentioned object, a method for manufacturing a multilayer optical recording medium of the invention is a method for manufacturing a multilayer optical recording medium including a plurality of signal recording layers in the signal recording and reading side, an interlayer of a resin layer between two layers of the signal recording layers, and a transparent protection layer with a thickness of 10 μm to 150 ∞m as an outermost layer, wherein the multilayer optical recording medium has a clamp area corresponding to a region inside of signal recording region, wherein the clamp area ranges in diameter from a diameter of 23 mm to the inner diameter of the signal recording region, the method includes:

preparing a substrate having the signal recording layers in the main surface side in the signal recording and reading side and projections in a region in the inner side than a diameter of 22 mm, wherein height difference between the height at a diameter of 23 mm and the height at a diameter of 21 mm is 20 μm or lower;

preparing a stamper;

applying a radiation-curable resin for the interlayer from the inner side than the clamp area of at least one of the substrate and the stamper;

laminating the substrate and the stamper to sandwich the radiation-curable resin between the substrate and the stamper;

curing the radiation-curable resin; and

separating the stamper from the substrate to obtain a radiation-curable resin layer after the curing as the interlayer on the substrate.

According to the method for manufacturing the multilayer optical recording medium of the invention, since height difference between the height at a diameter of 23 mm and the height at a diameter of 21 mm is 20 μm or lower, the effect of the height difference of the substrate is slight. Further, since a radiation-curable resin for the interlayer can easily be applied from the inner side of the diameter of 23 mm of the substrate, the flatness of the clamp area in the edge region, a region of a diameter of 23 mm or wider, to form a clamp area can reliably be attained. Further, owing to the radiation-curable resin, signals are easily and stably transferred from the stamper.

Further, in the above-mentioned method for manufacturing a multilayer optical recording medium, one single interlayer may be formed using two kinds of radiation-curable resins. According to the above-mentioned configuration, two resins may be selected in a manner that both of the adhesive force between the substrate and the interlayer and separability of the interlayer and the stamper can simultaneously be satisfied. Therefore, a more stable signal transfer and separation can be realized. Further, since the separability from the stamper is improved, separation of the interlayer from the substrate in the clamp area can be prevented.

In the above-mentioned method for manufacturing a multilayer optical recording medium, in the case the two kinds of the radiation-curable resins are defined as radiation-curable resins A and B;

the radiation-curable resin A is applied to the stamper,

the radiation-curable resin B is applied to the substrate,

the stamper and the substrate may be laminated with each other in a manner than the radiation-curable resin A and the radiation-curable resin B are sandwiched between them to form a single interlayer by sticking the radiation-curable resin A and the radiation-curable resin B.

Further, in the above-mentioned method for manufacturing a multilayer optical recording medium, it is preferable to apply the radiation-curable resins A and B in a manner that the inner diameter R(A) of the radiation-curable resin A applied to the stamper at the application position and the inner diameter R(B) of the radiation-curable resin B applied to the substrate at the application position satisfy the following relation:

R(B)=<R(A). The above-mentioned manufacturing method makes it possible to produce a multilayer optical recording medium satisfying the relation DUVB=<DUVA for the inner diameter DUVA of the area where the radiation-curable resin A is formed and the inner diameter DUVB of the area where the radiation-curable resin B is formed. According to the above-mentioned configuration, since the application area of the radiation-curable resin A which is to be separated from the stamper is covered with the radiation-curable resin B which secures the adhesion between the substrate and the interlayer, the separability can be improved and the flatness of the interlayer can be improved.

With respect to the above-mentioned method for manufacturing the multilayer optical recording medium, in a case the multilayer optical recording medium includes a plurality of signal recording layers and a plurality of interlayers wherein there are n (n is 2 or higher) in number of signal recording layers arranged from the first signal recording layer, . . . the (n−1)^{th} signal recording layer, to the n^{th} signal recording layer from the substrate side toward the transparent protection layer as the outermost layer, and an interlayer existing between the k^{th} (k is 1 or higher and (n−1) or lower) signal recording layer and the (k+1)^{th} signal recording layer is defined as the k^{th} interlayer and

in the step of applying the radiation-curable resins for forming the interlayer in at least one of the substrate and the stamper, it is preferable to apply the respective radiation-curable resins in a manner that the inner diameter R (k) of the radiation-curable resin to be applied for forming the k^{th} interlayer at the application position and the inner diameter R (k+1) of the radiation-curable resin to be applied for forming the (k+1)^{th} interlayer at the application position satisfy the following relation:

R(k)=<R(k+1).

Further, it is also preferable to apply the radiation-curable resin in a manner that the inner diameter R(n−1) of the radiation-curable resin to be applied for forming the (n−1)^{th} interlayer at the application position and the inner diameter RC of the radiation-curable resin to be applied for forming the transparent protection layer at the application position satisfy the following relation:

R(n−1)=<RC.

In the case the diameter of the inner circumferential edge of a region where the k^{th} interlayer is formed is defined as DSL (k) and the diameter of the inner circumferential edge of a region where the transparent protection layer is formed is defined as DCV, the manufacturing method provides a multilayer optical recording medium satisfying the following relation:

DSL(m−1)=<DSL (m) wherein m (m is 2 or higher and n−1 or lower) denotes an arbitrary number and

DSL(n−1)=<DSV.

According to the above-mentioned configuration, even if the number of the signal recording layers and also the number of the interlayers are increased and in the case of forming the respective interlayers, since an interlayer is formed on the entire face to be a base, the edge parts of the regions where the interlayers are to be formed, particularly the inner circumferential edges are also neatly coated. Accordingly, the flatness of the clamp area can be retained. Further, the inner circumferential edge of the transparent protection layer of the outermost layer to be formed on the interlayer can be formed neatly and the flatness of the clamp area of the transparent protection layer can also be retained.

The method for manufacturing the multilayer optical recording medium may further include curing the radiation-curable resin A or B by irradiating with a radiation beam. In this case, it is preferable to carry out radiation beam irradiation with the intensity distribution of the radiation beam to be irradiated to the inner side region than the inner diameter of the signal recording region in the radius direction.

Further, in the method for manufacturing the multilayer optical recording medium, at the time of curing the radiation-curable resin A or B, the inner side region than the inner diameter of the signal recording region in the radius direction, the radiation beam irradiation is carried out with a lowered intensity of the radiation beam irradiated to the signal recording region to make the curing degree lower than that in the signal recording region. According to the configuration, the separation of the interlayer is made stable in the inner side region, that is, the clamp area, than the inner diameter of the signal recording region and the flatness of the interlayer is improved and as a result, the formation of the transparent protection layer can be stabilized to improve the flatness of the clamp area.

Further, at the time of curing the radiation-curable resin A or B, the intensity of the radiation beam irradiated to the inner side region than the inner diameter of the signal recording region in the radius direction may be lowered to 35% to 85% of the irradiation intensity of the radiation beam in the signal recording region.

In the method for manufacturing the multilayer optical recording medium, it is preferable that the projections in the substrate are projected out of the surface of the transparent protection layer of the outermost layer layered on the substrate. According to the above-mentioned configuration, even when the multilayer optical recording medium is set in a manner that the transparent protection layer is set downward to a plane, the projections are brought into contact with the plane and the surface of the multilayer optical recording medium is prevented from being scratched.

Further, in the method for manufacturing the multilayer optical recording medium, at the time when the stamper is laminated face to face on the substrate, it is preferable to use a stamper having depression-like projection escapes for escaping from the projections at the positions corresponding to the projections of the substrate. According to the configuration, in the case the substrate has projections, at the time of the stamper and the substrate are laminated interposing their interlayers in between to form an interlayer, the interference of the stamper with the projections on the substrate can be prevented by the projection escapes.

In the method for manufacturing the multilayer optical recording medium, the method may further include spreading the radiation-curable resin by spinning the substrate and the stamper. According to the configuration, since the interlayer can be set in the plane by spinning the substrate and the stamper together, the method is excellent in mass productivity.

Further, in the method for manufacturing the multilayer optical recording medium, the method may further include spreading the radiation-curable resin by spinning at least one of the substrate and the stamper. According to the configuration, since the radiation-curable resin is spread in the plane before the substrate and the stamper are laminated, the inner diameter of the region where the interlayer is to be formed can be controlled easily. As a result, the flatness of the clamp area can be kept stably.

Further, in the method for manufacturing the multilayer optical recording medium, it is preferable to form the interlayer from the inner side of a diameter of 22.5 mm. According to the above-mentioned configuration, since the interlayer is formed from a further inner side than a diameter of 23 mm, the flatness of the transparent protection layer in the outer side of a diameter of 23 mm can be improved.

In the case of using the radiation-curable resins A and B for the two kinds of the radiation-curable resins, the above-mentioned method for manufacturing the multilayer optical recording medium may further include:

(a) dropping and spreading the radiation-curable resin A on the stamper in a plane-like state on the stamper and thereafter curing the radiation-curable resin A by irradiating with a radiation beam;

(b) arranging the radiation-curable resin B between the stamper and the substrate and spreading the radiation-curable resin B by spinning the substrate and the stamper together; and

(c) curing the radiation-curable resin B by irradiating with a radiation beam.

Further, in the case of using the radiation-curable resins A and B for the two kinds of the radiation-curable resins, the method may further include:

(a) dropping and spreading the radiation-curable resin B on the stamper in a plane-like state on the substrate and thereafter curing the radiation-curable resin B by irradiating with a radiation beam;

(b) arranging the radiation-curable resin A between the stamper and the substrate and spreading the radiation-curable resin A by spinning the substrate and the stamper together; and

(c) curing the radiation-curable resin A by irradiating with a radiation beam.

According to the above-mentioned two configurations, the transfer property and separability are secured by the radiation-curable resin A and adhesion can be secured by the radiation-curable resin B. Further, foams mixed in the interlayer can be pushed out of the recording medium by the extension.

In the case of using the radiation-curable resins A and B for the two kinds of the radiation-curable resins, the above-mentioned method for manufacturing the multilayer optical recording medium may further include:

(a) dropping and spreading the radiation-curable resin A on the stamper in a plane-like state on the stamper and thereafter curing the radiation-curable resin A by irradiating with a radiation beam;

(b) dropping the radiation-curable resin B on the substrate and spreading the radiation-curable resin B by spinning the substrate; and

(c) laminating the substrate and the stamper in a manner that the radiation-curable resins A and B are sandwiched between them under reduced pressure and thereafter curing the radiation-curable resin B by irradiating with a radiation beam.

Further, in the case of using the radiation-curable resins A and B for the two kinds of the radiation-curable resins, the method may further include:

(a) dropping and spreading the radiation-curable resin B on the substrate in a plane-like state on the substrate and thereafter curing the radiation-curable resin B by irradiating with a radiation beam;

(b) dropping the radiation-curable resin A on the stamper and spreading the radiation-curable resin A by spinning the stamper; and

(c) laminating the substrate and the stamper in a manner that the radiation-curable resins A and B are sandwiched between them under reduced pressure and thereafter curing the radiation-curable resin A by irradiating with a radiation beam.

According to the above-mentioned two configurations, the transfer property and separability are secured by the radiation-curable resin A and adhesion can be secured by the radiation-curable resin B. Further, mixing of foams in the interlayer can be prevented owing to the lamination under reduced pressure.

The method for manufacturing the multilayer optical recording medium may further include:

dropping a radiation-curable resin for forming the transparent protection layer on a cap in the case of using the cap for clogging the center hole of the substrate;

spreading the radiation-curable resin by spinning the substrate; and

curing the radiation-curable resin by irradiating with a radiation beam to form the transparent protection layer after removing the cap. In this case, the diameter of the cap is preferable to be wider than the inner diameter of the region where the interlayer is formed and is a diameter of 24 mm or less. According to the configuration, use of the cap at the time of dropping makes the thickness distribution of the transparent protection layer (particularly in the inner circumferential region of the signal recording region) uniform. Further, if the cap diameter is 24 mm or less, the diameter of the inner circumferential edge of the radiation-curable resin after cap removal becomes 23 mm or less and thus the transparent protection layer can be made flat in the clamp area with a diameter of 23 mm or more.

In the method for manufacturing the multilayer optical recording medium, the diameter of the center hole of the stamper is smaller than the diameter of the center hole of the substrate and in the step of separating the stamper from the substrate, the stamper may be separated by applying stress to the peripheries of the center hole of the stamper in the inner side than the center hole of the substrate in the direction opposed to the side where the substrate exists. According to the above-mentioned configuration, the stamper can stably and easily be separated only by pushing the peripheries of the center hole of the stamper. Further, as another method, a stamper having no center hole may also be used.

As described above, in the method for manufacturing a multilayer optical recording medium according to the invention, since the height difference of the substrate is 20 μm or less and the interlayer is formed from the inner side of a diameter of 23 mm, a multilayer optical recording medium excellent in the flatness of the clamp area can be obtained. The multilayer optical recording medium obtained accordingly does not tilt while being held at the time of recording or reading and stable and good signals can be obtained.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a schematic cross-sectional view showing a configuration of a multilayer optical recording medium according to the first embodiment of the invention;

FIG. 2 is a schematic view showing a dropping method of a radiation-curable resin for an interlayer in the method for manufacturing the multilayer optical recording medium according to the first embodiment of the invention;

FIG. 3 is a schematic cross-sectional view showing a configuration of a mold for producing a substrate of the multilayer optical recording medium according to the first embodiment of the invention;

FIG. 4 is a drawing showing spreading the radiation-curable resin for an interlayer by rotating the substrate and a stamper;

FIG. 5 is a drawing showing curing the radiation-curable resin for an interlayer by irradiating with a radiation beam;

FIG. 6 is a drawing showing separating the stamper from the substrate;

FIGS. 7A to 7D are drawings showing the relation between the sizes of the step and the return;

FIG. 8 is a drawing showing a method of forming a signal recording film;

FIG. 9 is a drawing showing a method of forming a transparent protection layer using a cap;

FIG. 10 is a drawing showing the state of the transparent protection layer before curing the transparent protection layer;

FIG. 11 is a schematic drawing showing a method of forming an intensity distribution of a radiation beam using a radiation beam-cutting filter at the time of irradiation with a radiation beam;

FIG. 12 is a drawing showing spreading the radiation-curable resin for the interlayer by spinning the substrate in the method for manufacturing a multilayer optical recording medium according to the second embodiment of the invention;

FIG. 13 is a drawing showing laminating the stamper and the substrate in a reduced pressure tank in the method for manufacturing a multilayer optical recording medium according to the second embodiment of the invention;

FIG. 14 is a drawing showing curing the radiation-curable resin for the interlayer in the method for manufacturing a multilayer optical recording medium according to the second embodiment of the invention;

FIG. 15 is a schematic drawing showing an example of using a pressure sensitive adhesive sheet as the radiation-curable resin for the interlayer in the method for manufacturing a multilayer optical recording medium according to second embodiment of the invention;

FIG. 16 is a schematic drawing showing steps of dropping the radiation-curable resin A on the stamper and spreading the resin by spinning the stamper in the method for manufacturing a multilayer optical recording medium according to the third embodiment of the invention;

FIG. 17 is a drawing showing laminating the stamper and the substrate in a reduced pressure tank in the method for manufacturing a multilayer optical recording medium according to the third embodiment of the invention;

FIG. 18 is a drawing showing spreading the radiation-curable resin for the interlayer by spinning the stamper and the substrate in the method for manufacturing a multilayer optical recording medium according to the third embodiment of the invention;

FIG. 19 is a schematic cross-sectional drawing showing the relation of the inner circumferential edge positions of a plurality of interlayers of a multilayer optical recording medium according to the fourth embodiment of the invention.

FIGS. 20A and 20B are drawings showing the method of separating the stamper in the method for manufacturing a multilayer optical recording medium according to the fifth embodiment of the invention;

FIGS. 21A and 21B are drawings showing the method of separating the stamper in the method for manufacturing a multilayer optical recording medium according to the fifth embodiment of the invention;

FIG. 22 is a schematic cross-sectional view showing the configuration of a conventional multilayer optical recording medium;

FIG. 23 is a plane view observed from the main face side of a conventional multilayer optical recording medium; and

FIG. 24 is a schematic cross-sectional view showing the configuration of a mold for a conventional stamper.

### DETAILED DESCRIPTION OF THE PREFERRED EMBODIMENTS

Hereinafter, a method for manufacturing a multilayer optical recording medium according to an embodiment of the invention will be described in detail with reference to attached drawings. In the drawings, same symbols are assigned to substantially same members.

### First Embodiment

### Multilayer Optical Recording Medium

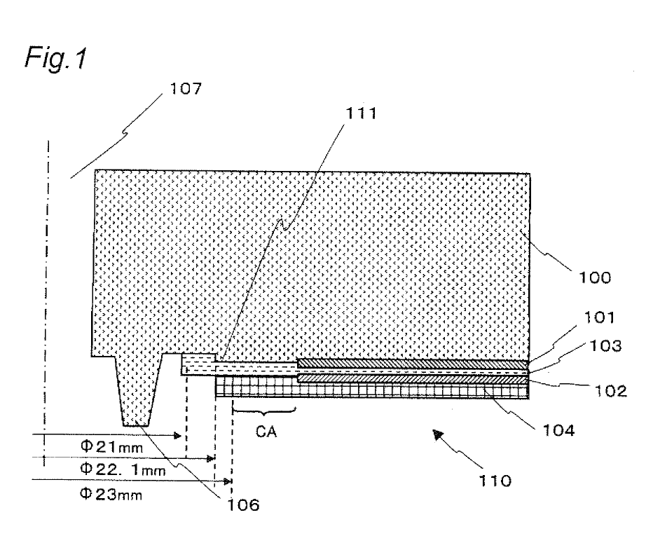

FIG. 1 is a schematic cross-sectional view showing a configuration of a multilayer optical recording medium 110 according to the first embodiment of the invention. This multilayer optical recording medium 110 is a dual layer optical recording medium having a first signal recording layer 101 and a second signal recording layer 102 interposing an interlayer 103 with a thickness of 25 μm in between. A transparent protection layer 104 with a thickness of 75 μm is formed on the second signal recording layer 102. That is, the layer thickness from the surface of the transparent protection layer 104 to the first signal recording layer 101 is 100 μm. The first signal recording layer 101 is formed by forming a multilayer recording film or a reflection film on guide grooves or pits formed on the substrate 100. In the case of using an optical head of NA 0.85 using a beam with a wavelength of 405 nm, if the guide grooves or pits at track pitches of 0.32 μm, the recording capacities of the respective signal recording layers are 23 to 27 GB. The multilayer recording film is made of a reflection film of silver, aluminum, or a nickel alloy; a dielectric layer containing, as a main component, zinc sulfide, aluminum nitride, or the like; a recording layer containing a compound of elements selected from Ge, Sb, Te, Ag, In, Bi, and the like; and so forth. Further, a coloring material may be used as a recording layer material. In the case the reflection film is formed independently, an alloy containing silver and aluminum as main components is used.

The portion of the transparent protection layer 104 in the inner circumference of the first and the second signal recording layers 101 and 102 is a clamp area CA. The inner diameter of the clamp area CA is 23 mm. The clamp area CA is a portion for holding the multilayer optical recording medium 110 at the time of recording or reading. Therefore, the surface of the clamp area CA has to be flat. In this multilayer optical recording medium 110, the interlayer 103 is formed not only in the clamp area CA but also in the inner side of a diameter of 21 mm. Therefore, the clamp area CA starting from the diameter of 23 mm is excellent in the flatness.

In this multilayer optical recording medium 110, a step 111 near the diameter of 22.1 mm of the substrate 100 is 20 μm or less to form the interlayer 103 to the more inner side. Further, a projection 106 is formed in a part in the inner side than the diameter of 21 mm of the substrate 100 in a portion to a center hole 107. The projection 106 is projected from the surface of the transparent protection layer 104. Since the projection 106 exists in the substrate 100, even if the multilayer optical recording medium 110 is put on a plane in a manner that the transparent protection layer 104 is set downward, the surface of the transparent protection layer 104 is kept apart from the plane, scratching of the surface of the transparent protection layer 104 can be prevented. The projection 106 is formed on the substrate 100 by forming a corresponding groove in a mold at the time of producing the substrate 100 by injection molding.

### [Method for Manufacturing Conventional Multilayer Optical Recording Medium]

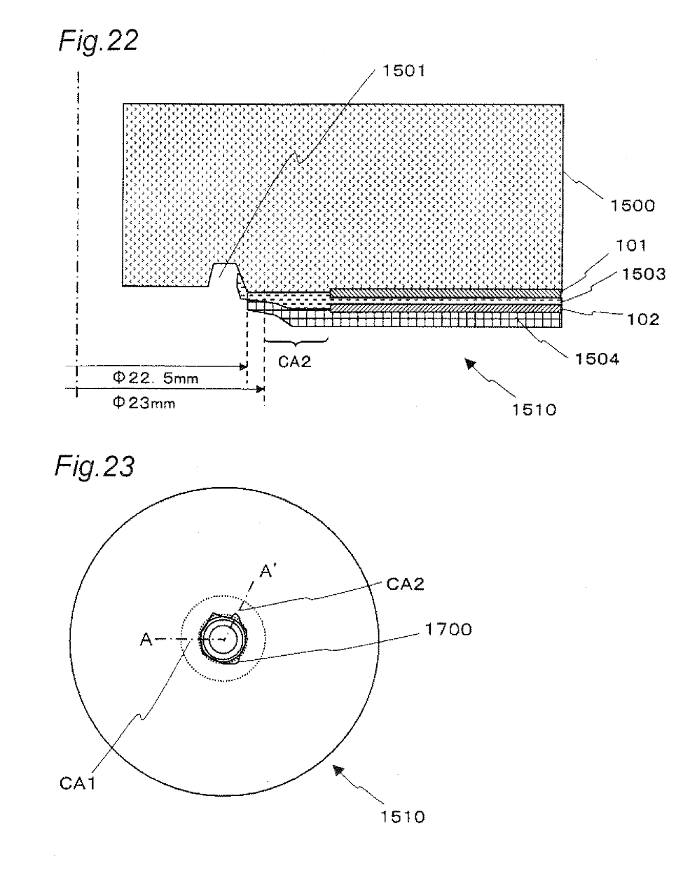

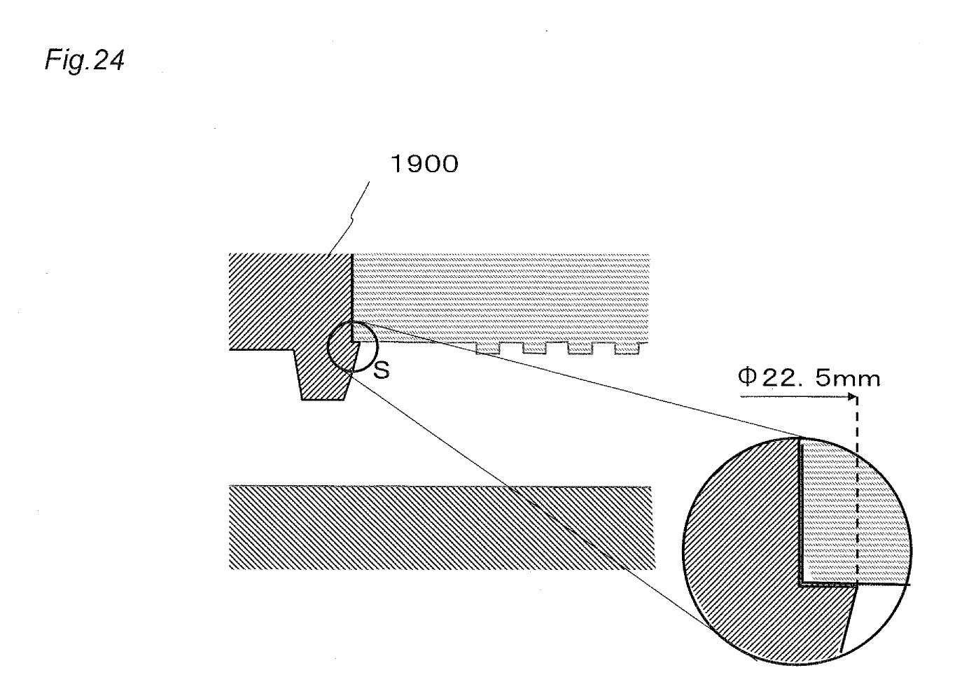

To explain the characteristics of the method for manufacturing the multilayer optical recording medium of the invention, a conventional multilayer optical recording medium and its manufacturing method will be described with reference to FIGS. 22 and 23 for comparison. A conventional multilayer optical recording medium 1510 differs in the following points from the multilayer optical recording medium 110 of the invention shown in FIG. 1:

a) there is a groove 1501 in the inner side than near the diameter of 22.5 mm;

b) because of the existence of the groove 1501, an interlayer 1503 is formed only in the outside of the outer circumferential end of the groove; and

c) there is no projection in the inner side of the groove 1051. The reason why there is no projection in the inner side of the groove 1051 is because the conventional multilayer optical recording medium 1510 is always used while being housed in a housing so-called a cartridge and thus the face of a transparent protection layer 1504 is protected and any projection is unnecessary.

The groove 1501 is formed in a substrate 1500 since the mold have a projection to be used for producing the substrate 1500 by injection molding. Specifically, a projection of 200 μm or higher is formed in the mold by a tool for holding the peripheral part of the center hole of a stamper for injection molding for forming guide grooves or pits in the first signal recording layer. That is, the depth of the groove 1501 is no less than 200 μm.

Because of the existence of the groove 1501, the inner circumferential side edge of the interlayer 1503 is close to the outer circumferential side edge of the groove 1501, that is, near the diameter of 22.5 mm. The clamp area on the interlayer 1503 is made flat up to the diameter of 23 mm in the radius direction; however, as shown in FIG. 22, the flatness of a clamp area CA2 becomes poor in another radius direction of the multilayer optical recording medium 1510. It is because the interlayer 1503 is formed even in the inside of the groove 1501 and the surface of the interlayer 1503 with a diameter of 23 mm is not flat and accordingly a portion of the interlayer 1503 having a thickness of only about 5 μm is formed. Therefore, the transparent protection layer 1504 on the surface is also deficient in the flatness and undulation of the surface of about 20 μm is generated to make the clamp area deficient in the flatness.

FIG. 23 is a plane view of the multilayer optical recording medium 1510 observed from the transparent protection layer 1504 side. The clamp area CA2 in FIG. 22 is a cross-section cut along A′ of the multilayer optical recording medium 1510. There is an inner circumferential edge 1700 in the region where the flatness is kept in the clamp area shown by the dotted line and the flatness is deteriorated just like in the inner circumferential part of the CA2 of FIG. 22 in the inner circumferential side. The inner circumferential edge 1700 in the region where the flatness is kept is not concentric with the doughnut-like clamp area. Therefore, if the multilayer optical recording medium 1510 is held by the clamp area, deformation occurs in the circumferential direction and warping change in the circumferential direction is caused. At the time of recording or reading, a problem that stable signal recording or reading becomes difficult is caused because signals are deteriorated due to the warping.

As compared with the conventional multilayer optical recording medium 1510 shown in FIGS. 22 and 23, with respect to the multilayer optical recording medium 110 according to the first embodiment of the invention, since the step 111 of the substrate 100 is 20 μm or less, the interlayer 103 may be formed from the inside. Therefore, good flatness can be secured in the clamp area beginning from the diameter of 23 mm.

### [Method for Manufacturing Multilayer Optical Recording Medium of the First Embodiment]

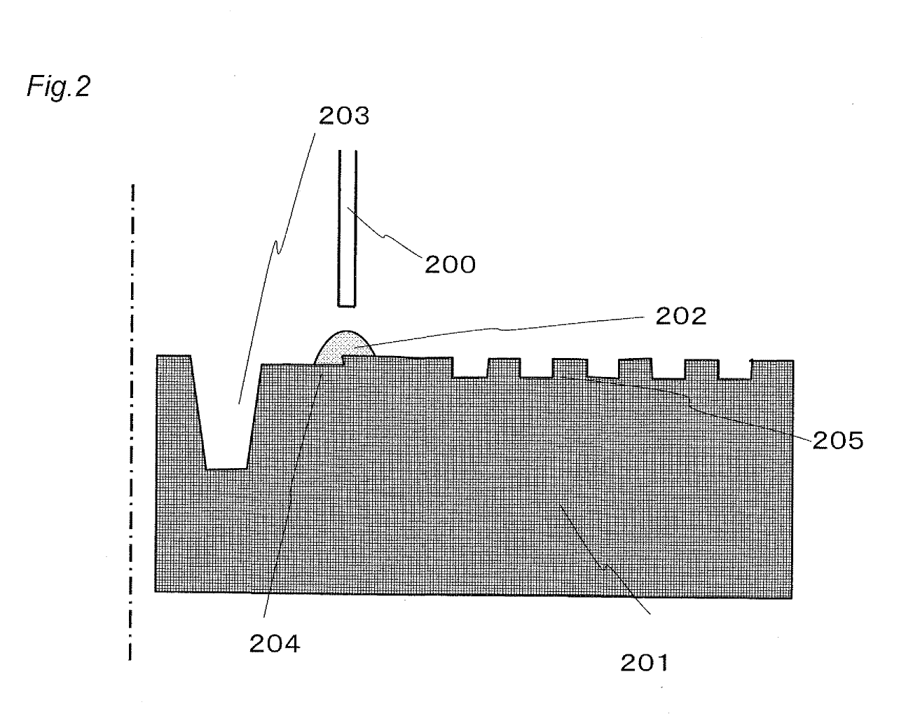

Next, the method for manufacturing a multilayer optical recording medium of the first embodiment of the invention will be described with reference to FIGS. 2 to 11. In this manufacturing method, a stamper made of a transparent olefin resin is used as a stamper for interlayer formation. As the olefin resin, Zeonoa (trade name) manufactured by Nippon Zeon Co., Ltd. is used.

(a) First, a stamper 201 made of olefin is prepared. The stamper 201 made of olefin may be produced by injection molding by using a master stamper made of, for example, nickel. Signals 205 of guide grooves or pits are transferred to the stamper 201 made of olefin. Further, in the case of using a holder 1900 having a projection to be used conventionally as a mold as shown in FIG. 24, a step 204 to be formed on the stamper 201 made of olefin becomes relatively large. On the other hand, in the case a holder 2001 having no projection is used as shown in FIG. 3 (a master stamper 2000 is caulked by a taper part 2002 for holding it), the step 204 formed on the stamper 201 made of olefin becomes very small. Further, since the master stamper 2000 is held only by the taper part 2002, the position of the step 204 can be set in the diameter of 22.1 mm, which is more inner circumference than the step position of 22.5 mm in the case of using the holder 1900. Further, in order to avoid interference of the projection 106 with the substrate 100, a projection escape 203 with a recession-like shape is formed at the point corresponding to the projection of the substrate 100.

(b) Next, as shown in FIG. 2, a radiation-curable resin 202 is dropped on the stamper 201 made of olefin by a dispensing nozzle 200. As a resin for the interlayer, a radiation-curable resin, an ultraviolet-curable resin or a thermosetting resin may be used. Herein, as the resin for the interlayer, DVD-003 (viscosity 450 mPa·s), an ultraviolet-curable resin manufactured by Nippon Kayaku Co., Ltd. is used. The radiation-curable resin 202 in an amount of 3 g is dropped in a ring-like state.

The dropping position of the radiation-curable resin 202 on the stamper 201 is determined in a manner that the inner circumferential edge of the completed interlayer is to be at a desired radius position (e.g. at a position of the diameter of 21 mm). Specifically, it is preferable to apply the radiation-curable resin 202 from the point of the inner circumferential side of the diameter of 23 mm or less corresponding to the inner circumferential edge of the clamp area.

(c) A substrate 100 having the first signal recording layer 101 formed in the main face side of the signal recording and reading side and a projection 106 in a region in the inner side than the diameter of 22 mm is prepared. Further, it is preferable to use a substrate having the step 111 of 20 μm or less at the position of the diameter of 23 mm and the position of the diameter of 21 mm on the main face as the substrate 100. In this substrate 100, the step 111 has height difference of about 20 μm or less near the diameter of 22.1 mm. The step 111 having height difference of about 20 μm or less can be made by producing it using a holder 2001 having no projection as shown in FIG. 3 at the time of producing the substrate 100 by injection molding. The projection 106 can be formed by producing the substrate 100 by injection molding using a holder having a recession-like shape.

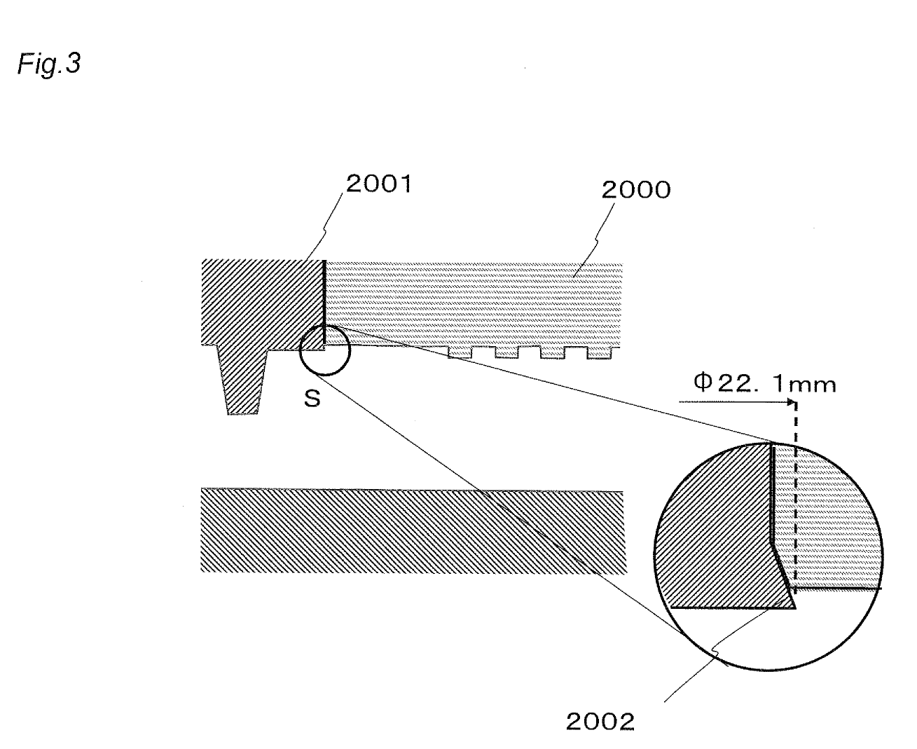

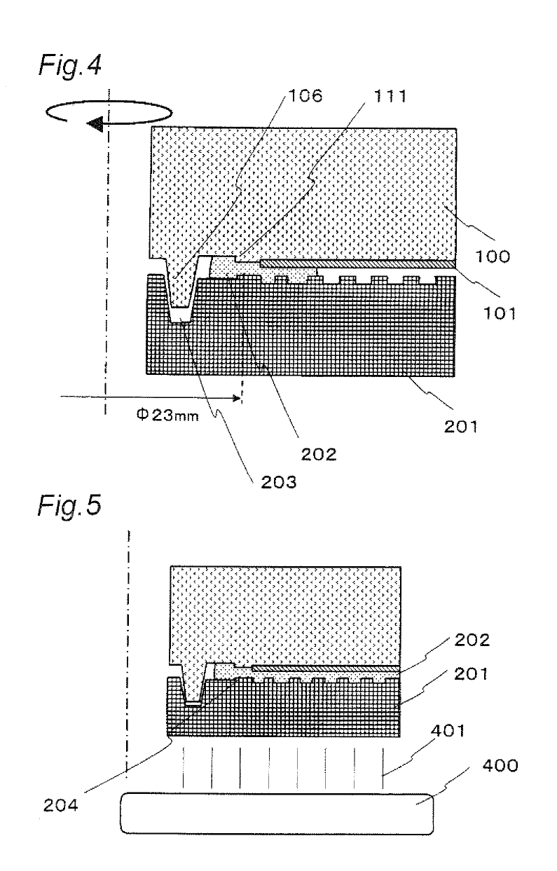

(d) Next, as shown in FIG. 4, the substrate 100 on which the first signal recording layer 101 is formed and the stamper 201 made of olefin are laminated while being set face to face. In this case, the projection 106 of the substrate 100 enters the recession-like projection escape 203 of the stamper 201 and there is no interference between them. The radiation-curable resin 202 is spread by the weight of the substrate 100 and spread to the inner circumferential side and the outer circumferential side from the dropped point.

(e) Both the substrate 100 and the stamper 201 are rotated at 4500 rpm for 5 seconds to spread the radiation-curable resin 202 to the outer circumference. Accordingly, the thickness of the radiation-curable resin 202 becomes about 25 μm.

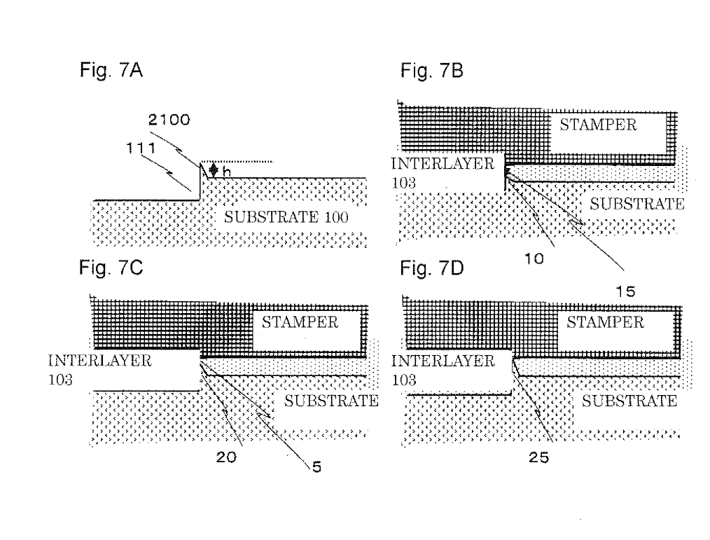

Herein, the relation between the size of the step 111 of the substrate 100 and flatness of the interlayer will be described with reference to the following Table 1 and FIG. 7. Table 1 is a table showing the relation between the size of the step 111 and flatness of the interlayer. Depending on the size of the step 111, a height h (refer to FIG. 7A) of a return 2100 formed in the part differs. The mechanism of generation of the return 2100 is as follows. First, the plastic resin to be used for molding the substrate enters the undercut part, which formed a portion of the taper part 2002 of the holder 2001 as shown in FIG. 3. Thereafter, when the substrate is taken out of the mold, the resin in the undercut part rises in the signal face side to form the return 2100. It is understood also from the following Table 1 that the return with approximately the same size as that of the step 111 is generated. The yield of the flatness in the clamp area in the interlayer is affected by the size of the step 111.

TABLE 1

| | Flatness | | |
|---|---|---|---|
| | | Flatness of | |
| | | interlayer of | |
| | Height h | diameter of 22.5 | Yield of |
| | of return | mm (occurrence | flatness in |
| Step | in step part | of separation) | clamp area |
| 10 μm or less | to 10 μm | ⊙ | 100% |
| 10 to 20 μm | 10 to 20 μm | ◯ | 80% |
| More than 20 μm | 20 μm | X | to 50% |

FIGS. 7B, 7C, and 7D are schematic drawings in the case the step 111 is 10 μm, 20 μm, and 25 μm, respectively. In the case the interlayer 103 with a thickness of 25 μm is formed, the gap with the stamper and the gap with the return of the substrate become 15 μm, 5 μm, and 0 μm, respectively. When the gap is narrowed, for example, the gap becomes 0 μm (the return and the substrate contact with each other), the flatness of the interlayer at the outer circumference of the step (at a position of the diameter of 22.1 mm) and at a position of the diameter of 22.5 mm is extremely deteriorated. That is, with the return, it was found that the interlayer was cut into an outer circumferential portion and an inner circumferential portion of the return and the interlayer of the diameter of 22.5 mm remained partially stuck to the stamper at the time of separating the stamper. Further, since the interlayer was stuck to the stamper side at a diameter of 23 mm, those which have no interlayer on a substrate were produced. As a result, the yield of flatness of the clamp area at a position of the diameter of 23 mm was considerably deteriorated after formation of the transparent protection layer. From this result, it can be understood that a multilayer optical recording medium can be produced at a high yield if the height difference on the substrate is 20 μm or less.

Additionally, if the mold shown in FIG. 3 is used for producing the substrate, the return is spontaneously generated and therefore, in the drawings except FIG. 7 showing the embodiment of the invention, the return is not particularly shown for simplification.

(d) Next, as shown in FIG. 5, a radiation beam 401 is irradiated from a radiation beam source 400 toward the stamper side 201 to cure the radiation-curable resin 202. Since the radiation-curable resin 202 is an ultraviolet-curable resin, an ultraviolet lamp is used as the radiation beam source 400. As the ultraviolet lamp, a mercury lamp, a halogen lamp, a xenon lamp or the like can be employed. Since the stamper 201 is relatively transparent to ultraviolet rays, the radiation-curable resin 202 can be cured.

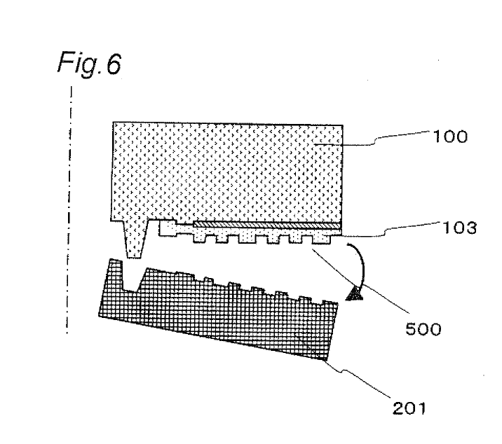

(e) Next, the stamper 201 made of olefin is separated from the substrate 100 as shown in FIG. 6. An olefin resin is generally weak in the adhesion strength to the radiation-curable resin 202, the radiation-curable resin 202 remains in the substrate 100 side and the stamper 201 made of olefin can stably be separated. Signals 500 transferred from the stamper 201 are formed in the interlayer 103 of the cured radiation-curable resin 202. A separation method may be a method of inserting a wedge-like tool between the substrate 100 and the olefin stamper 201 and mechanically separating the stamper and a method of introducing compressed air together with a wedge-like tool and separating the stamper. The dropping point shown in FIG. 2 may be determined in a manner that the inner circumferential edge of the interlayer 103 after separation is formed up to the inner side of the diameter of 23 mm. In the case of forming the transparent protection layer, the process margin can be widened if it is formed up to the inner side of the diameter of 22.5 mm.

The interlayer formation method is described above, and a method for forming the second signal recording layer and a method for forming a transparent protection layer will be described in the following.

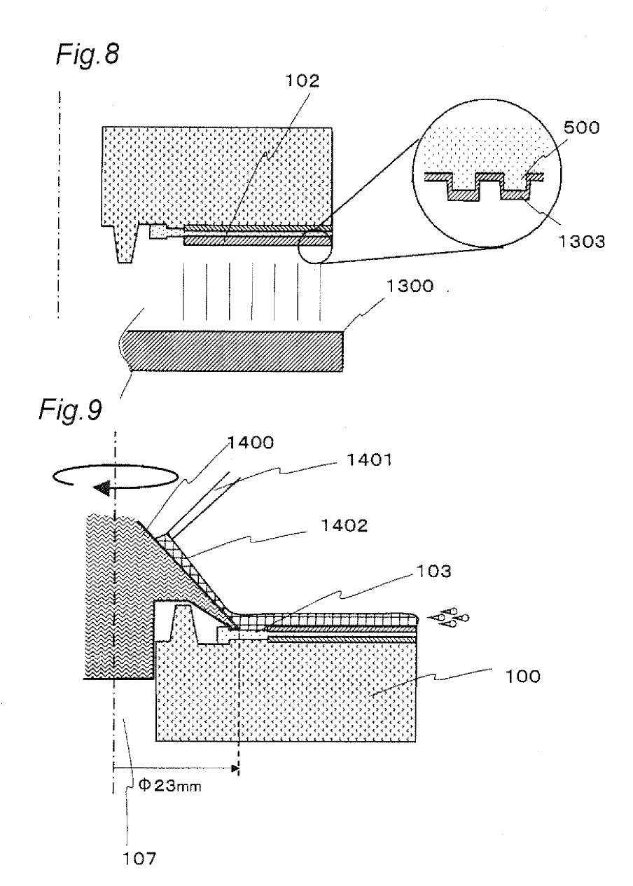

(f) Next, a method for forming the second signal recording layer will be described. FIG. 8 is a schematic drawing showing the method for forming the second signal recording layer. The second signal recording layer 102 is formed of signals 500 formed on the interlayer and a second signal recording film 1303. The second signal recording layer 102 is also produced from the same material as that of the first signal recording layer 101. That is, the second signal recording film 1303 is a multilayer recording film or a reflection film. The multilayer recording film include a reflection film of silver, aluminum, or a nickel alloy; a dielectric layer containing, as a main component, zinc sulfide, aluminum nitride, or the like; a recording layer containing a compound of elements selected from Ge, Sb, Te, Ag, In, Bi, and the like; and so forth. Further, a coloring material may be used as a recording layer material. In the case the reflection film is formed independently, an alloy containing silver and aluminum as main components is used. The second signal recording film 1303 is formed by sputtering. The second signal recording film 1303 is formed by sputtering using a sputtering target 1300 made of a desired material. In the case the second signal recording film 1303 consists of a plurality of layers, the layers of the film are layered by sputtering a plurality of times using desired targets. Further, a coloring material film or the like may be formed by a vapor deposition method or a spin coating method in addition to the sputtering.

### [Formation of Transparent Protection Layer Using Cap]

(g) Further, a method for forming a transparent protection layer will be described. FIG. 9 is a drawing showing one example of a method for forming a transparent protection layer using a cap 1400.

(i) Using the cap 1400 to be fitted in the center hole 107 of the substrate 100, the cap is arranged so as to clog the center hole 107 of the substrate 100. The outer diameter of the cap 1400 is 24 mm or smaller in diameter and is wider than the inner circumferential edge of the region where the interlayer 103 is formed. Since the interlayer is formed up to the inner side than 22.5 mm, a cap having an outer diameter of 23 mm is used.

(ii) A radiation-curable resin 1402 for a transparent protection layer is dropped from the upper side of the cap 1400 by a dispensing nozzle 1401 and the substrate 100 is rotated. Similarly to the interlayer, an ultraviolet-curable resin may be used as the radiation-curable resin 1402 for the transparent protection layer. Herein, an ultraviolet-curable resin having a viscosity of 2000 mPa·s is used as one example. In addition, a thermosetting resin may be used. The radiation-curable resin 1402 in an amount of 1.5 g is dropped in a ring-like state to the cap 1400 and the rotation speed of the substrate 100 is increased to 4650 rpm in an acceleration time of 0.7 seconds and thereafter, maintained for 0.8 seconds. Accordingly, the thickness of the radiation-curable resin 1402 becomes about 75 μm.

(iii) Thereafter, the radiation-curable resin 1402 is cured by using an ultraviolet lamp. As the ultraviolet lamp, a mercury lamp, a halogen lamp, a xenon lamp and the like can be employed. Although a mounting part of the radiation-curable resin 1402 is formed in the outer circumferential rim of the substrate 100, it can be removed by means of curing the radiation-curable resin 1402 while rotating the substrate 100, for example.

Through the above-mentioned steps, the multilayer optical recording medium can be produced.

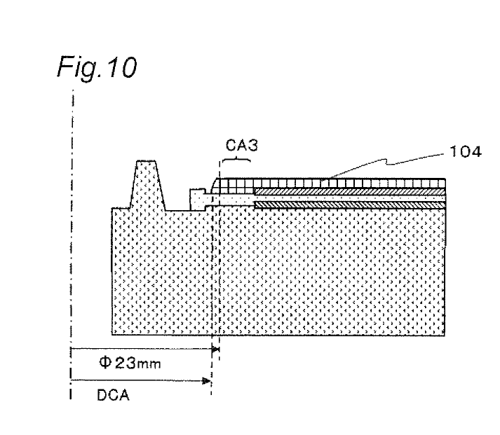

FIG. 10 is a schematic drawing showing the configuration of the multilayer optical recording medium produced by the method shown in FIG. 9. In the case the transparent protection layer 104 is formed using the cap 1400 with an outer diameter of 23 mm, the radiation-curable resin 1402 flows to the inner circumferential side than the diameter of 23 mm and reaches the diameter DCA in a period of curing after removal of the cap 1400 and therefore, in a clamp area CA3, the flatness of at least the outer side than the diameter of 23 mm can be obtained. The following Table 2 shows the relation between the outer diameter of the cap and the flatness of the clamp area. It can be understood that if the outer diameter of the cap is 23 mm, the flatness is excellent even at the position of the diameter of 23 mm. However, it is also understood that the flatness is lost as the outer diameter of the cap becomes wider and the flatness gradually becomes 20 μm or more. From this Table, if the outer diameter of the cap is 24 mm or less, the flatness is less than 20 μm and it is no problem in terms of signal recording or reading.

TABLE 2

| | Flatness | | |
|---|---|---|---|
| | Flatness of | Flatness of | Flatness of |
| | transparent | transparent | transparent |
| | protection | protection | protection |
| Outer | layer of | layer of | layer of |
| diameter of | diameter of | diameter of | diameter of |
| cap | 24 mm | 23.5 mm | 23 mm |
| 25 mm | ◯ | X | X |
| 24 mm | ⊙ | ⊙ to ◯ | ◯ |
| 23.5 mm | ⊙ | ⊙ | ⊙ to ◯ |
| 23 mm | ⊙ | ⊙ | ⊙ |

### [Use of Radiation Beam-Cutting Filter]

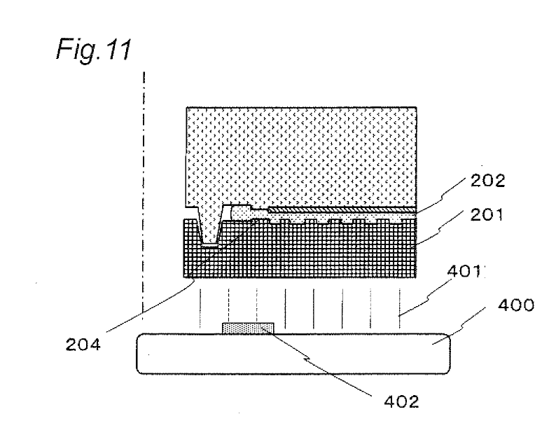

In the step of curing the radiation-curable resin 1402 by irradiating with a radiation beam in the method for manufacturing the multilayer optical recording medium, a method of controlling the transmittance of the radiation beam in the inner side than the signal recording region by using a radiation beam-cutting filter will be described with reference to FIG. 11.

If there is a step 204 in the inner side of the signal region of the stamper 201, the radiation-curable resin 202 near the step 204 cannot be transferred and is separated to generate resin scum at the time of separating the stamper 201 in some cases. To prevent that, in the inner side than the signal region as shown in FIG. 11, a radiation beam-cutting filter 402 is preferably installed between the radiation source 400 and the stamper 201 for partially decreasing the curing degree. Herein, the transmittance of the radiation beam-cutting filter 402 is controlled to be about 65%. Decrease of the curing degree of the radiation-curable resin 202 in the periphery of the step 204 prevents generation of the return due to the step 204 or formation of resin scum by separation at the time of separation from the stamper 201. Consequently, deficiency of the flatness in the clamp area attributed to the resin scum can remarkably be eliminated. The following Table 3 shows the relation of the resin scum generation frequency and the curing degree in relation to the transmittance (the transmittance of the signal recording region without using a cutting filter is standardized to be 100%) of a part to which the radiation beam-cutting filter is stuck. From this Table 3, it can be understood that if the transmittance of the part to which the radiation beam-cutting filter is stuck is in a range from 35% to 85%, both of suppression of resin scum generation and the curing degree can simultaneously be satisfied. If the transmittance is in a range of from 35% to 85%, the radiation intensity of the radiation beam in the part becomes 35% to 85% of the luminous intensity in the part having no radiation beam-cutting filter (signal recording region).

TABLE 3
Transmittance of part to which radiation Resin scum
Curing beam-cutting filter is stuck (transmittance
of signal generation degree recording region without
using cutting filter is standardized to be 100%)

| | | |
|---|---|---|
| 90% | X | ⊙ |
| 85% | ◯ | ⊙ |
| 65% | ⊙ | ⊙ |
| 35% | ⊙ | ◯ |
| 28% | ⊙ | X |

As described above, in the first embodiment, the multilayer optical recording medium having a step 111 having height difference of 20 μm or less in the substrate and an interlayer formed up to the inner side of the diameter of 23 mm and is excellent in flatness of the clamp area is described. Since this multilayer optical recording medium is excellent in the flatness of the clamp area, the multilayer optical recording medium does not tilt while being held at the time of recording or reading and stable and good signals can be obtained.

Although the stamper made of olefin is used as the stamper for interlayer formation in this first embodiment, resin materials, e.g. an acrylic resin such as PMMA and a norbornene type resin with low adhesion power to the radiation-curable resin as well as glass or the like may be used for the stamper as long as it is transparent. Further, as a material for the substrate 100, other materials such as polycarbonate may be used as long as they have higher adhesion power to the radiation-curable resin than the stamper 201. Furthermore, as a resin for the transparent protection layer and the interlayer, a thermosetting resin is also usable besides the radiation-curable resin and the ultraviolet-curable resin. In this case, the radiation-curable resin has to be selected from those easier to stick to the substrate or the first signal recording layer than the stamper. Further, in FIG. 5, the radiation beam 401 is irradiated from the side of the stamper 201 made of olefin; however it may be irradiated from the substrate side. In the case the first signal recording layer has some transmittance to the radiation beam to be employed, it is possible to cure the radiation-curable resin 202 via the first signal recording layer by irradiation from the substrate side. Although the radiation-curable resin 202 is dropped on the stamper 201 made of olefin in FIG. 2, it may be dropped on the substrate 100 and then laminated with the stamper 201 and rotated together. Further, the radiation-curable resin may be dropped on both of the substrate 100 and the stamper 201.

To form the transparent protection layer, a film made of plastic (e.g.

Pure-Ace (trade name) from Teijin Chemicals, Ltd.: a film made of polycarbonate) may be used and stuck with a radiation-curable resin (e.g. an ultraviolet-curable resin) and a pressure sensitive adhesive to form the transparent protection layer. Additionally, even in the case of using a film as the transparent protection layer, if the flatness of the interlayer to be a base is deficient, the flatness of the surface of the transparent protection layer becomes deficient. According to the method for manufacturing the multilayer optical recording medium of first embodiment of the invention, since the interlayer is provided with good flatness and therefore, the flatness of the surface of the transparent protection layer also becomes good.

### Second Embodiment

In this second embodiment, a method for manufacturing a read only (ROM type) multilayer optical recording medium as a second method for forming the interlayer will be described.

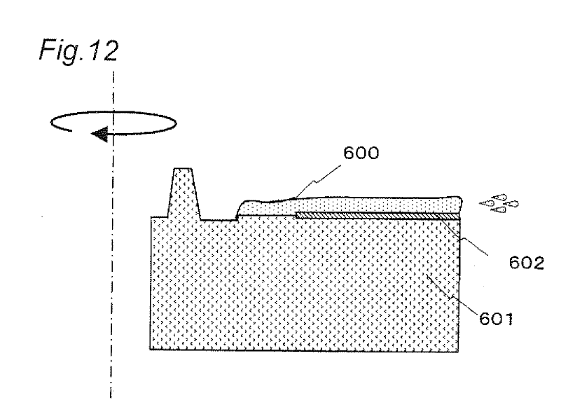

(a) As shown in FIG. 12, a radiation-curable resin 600 is dropped on a substrate 601 and the substrate 601 is rotated to spread the radiation-curable resin 600 to the outer circumferential rim of the substrate. As the radiation-curable resin 600, those same as described in the first embodiment are usable. Herein, DVD-003 same as in the first embodiment is used. Further, with respect to the substrate 601, those same as described in the first embodiment are usable; however polycarbonate is optimum. A first signal recording layer 602 is of a material having some transmittance to ultraviolet rays. In the case of a read only optical recording medium, a reflection film of a silver alloy can be exemplified. If the reflection film is of a silver alloy, a sufficient reflected light quantity can be obtained to the reading wavelength and the transmittance of ultraviolet rays is high in the case of a thickness of 40 nm.

The rotation speed and rotation time in the case the substrate 601 is rotated may be selected from various suitable conditions to adjust the thickness of the layer of the radiation-curable resin 600 to be about 25 μm. Further, a cap shown in FIG. 9 may be used and the radiation-curable resin 600 is dropped from the upper side of the cap and then the substrate 601 may be rotated. Use of the cap makes it possible to form the layer of the radiation-curable resin 600 with a more uniform thickness.

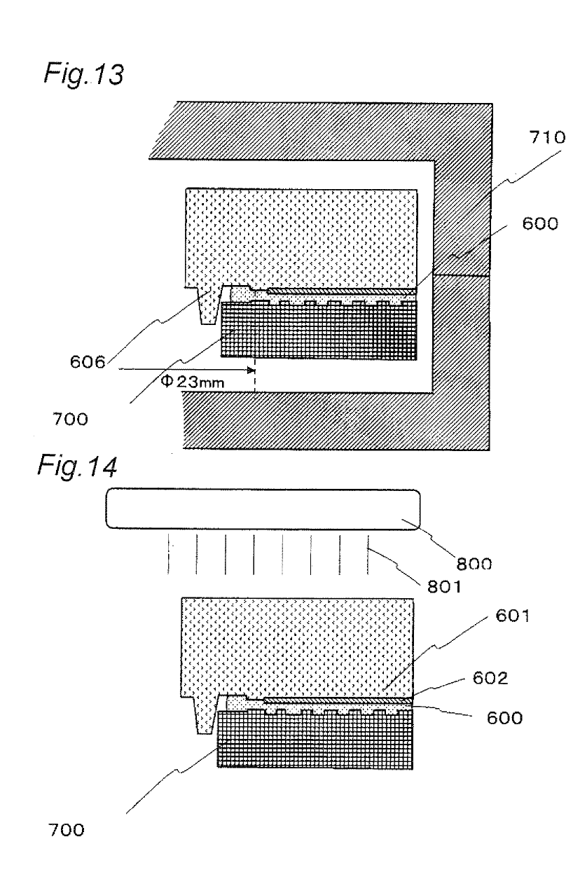

(b) Next, as shown in FIG. 13, the substrate 601 and a stamper 700 are laminated in a reduced pressure tank 710. The stamper 700 is a stamper made of a metal such as nickel. The center hole diameter of the stamper 700 to be used is wider than the outer diameter of a projection 606 of the substrate 601. It is because in the case of a stamper made of a metal, the depression-like projection escape for preventing the interference with the projection 606 is difficult to be produced. If the lamination is carried out in an atmosphere pressure-reduced to 2 kPa, occurrence of entrainment of foams between the stamper 700 and the radiation-curable resin 600 can be prevented. Further, after lamination, it is preferable, as shown in FIG. 13, that the radiation-curable resin 600 reaches the inner side than the diameter of 23 mm, for example, the inner side of the 22.5 mm.

(c) After the substrate 601 and the stamper 700 are laminated, as shown in FIG. 14, a radiation beam 801 is irradiated using a radiation beam source 800 from the side of the substrate 601. Herein, the radiation beam 801 is ultraviolet rays and the lamps same as described in the first embodiment can be usable as the radiation beam source 800. The reason for irradiating with the radiation beam 801 from the substrate 601 side is because the stamper 700 is made of a metal and does not transmit ultraviolet rays, which is a radiation beam. Ultraviolet rays can pass through the first signal recording layer 602 of a silver alloy and cure the radiation-curable resin 600.

(d) Thereafter, a wedge-like tool or compressed air is introduced between the substrate 601 and the stamper 700 to separate the stamper 700 from the substrate 601.

(e) Next, in the same manner as the method shown in FIG. 8, a silver alloy reflection film of having a thickness of 22 nm is formed as the second signal recording layer 102.

(f) Further, a transparent protection layer 104 is formed in the same manner as the method shown in FIG. 9.

The interlayer and the transparent protection layer can be formed by the above-mentioned method and the multilayer optical recording medium having the clamp area excellent in the flatness can be obtained. Securement of the flatness in accordance with the inner diameter of the region where the interlayer is formed and the outer diameter of the cap is explained in first embodiment and therefore, the explanation is omitted.

Although the radiation-curable resin 600 is dropped on the substrate 601 and spread in this second embodiment, it may be dropped on the stamper 700 and spread by rotating the stamper 700. Further, the resin may be dropped on both of the substrate 601 and the stamper 700. Further, as an example, the ROM type optical recording medium is employed for explanation, the first and the second signal recording layers may be a multilayered recording film. However, the materials have to be those having some transmittance to the radiation beam to be used.

In FIG. 14, the radiation beam 801 is irradiated only from the substrate 601 side; however other radiation beams may be irradiated from the stamper 700 side to promote the curing of the radiation-curable resin 600. For example, in the case of an ultraviolet-curable resin, heat may be applied by infrared rays or far infrared rays from the stamper 700 side to promote curing. Further, as the stamper 700, those made of non-transparent plastic may be used and also those made of glass and plastic having transparency (olefin type, norbornene type, acrylic type, and the like) may be used instead of those made of metals. For example, the olefin stamper used in the first embodiment may be used as it is to carry out the manufacturing method of this second embodiment. In the case of a transparent stamper, radiation beams having some transmittance of the stamper such as ultraviolet rays may be irradiated from the stamper side to promote the curing.

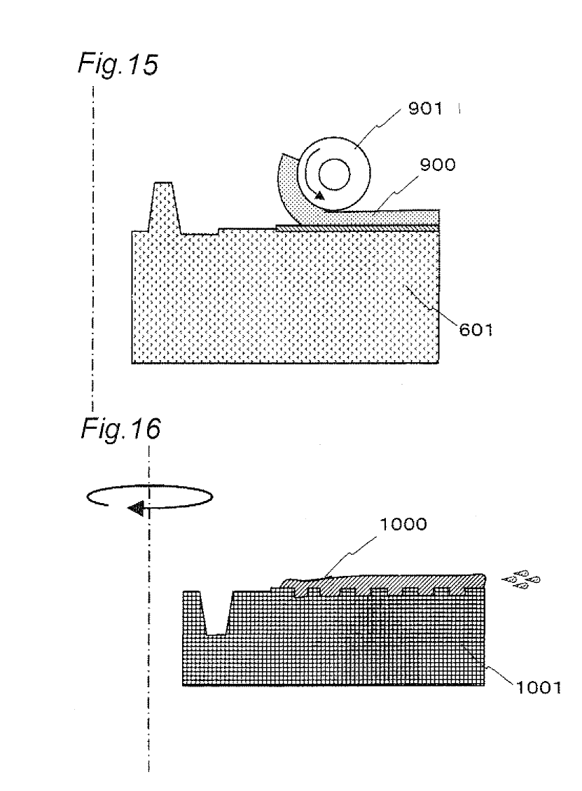

As shown in FIG. 15, in place of the radiation-curable resin 600, a UV-PSA sheet 900 may be used. A UV-PSA sheet is a pressure sensitive adhesive and provided with ultraviolet-curable properties. The UV-PSA sheet has an extremely high viscosity and is in gel-state and thus it can be handled like a film and the inner diameter of the interlayer can be controlled by the inner diameter of the UV-PSA sheet. Further, the sheet can easily be stuck to the substrate 601 by a roller 901 and mixing of foams between the sheet and the substrate 601 can be prevented even in the atmospheric air. Further, owing to the gel-state, the signals on the stamper 700 can also be transferred.

Similarly to the first embodiment, a film made of plastic may be used at the time of forming the transparent protection layer.

### Third Embodiment

In the third embodiment, a process for forming one of the interlayers using two kinds of radiation-curable resins will be described. The two kinds of radiation-curable resins may be a radiation-curable resin A to be brought into contact with the stamper for transferring signals from a stamper and easy to be separated from a stamper and a radiation-curable resin B to be brought into contact with the substrate, easy to be stuck to the substrate, and to be stuck to the radiation-curable resin B. This method is particularly effective for the case that the material of the stamper is hard to be separated from the radiation-curable resin of the interlayer. For example, in the case the materials of the substrate and the stamper are the same, if the radiation-curable resin having good separability from the stamper is used, there occurs a problem that the resin is easy to be separated also from the substrate for the same resins. Therefore, the radiation-curable resin A having good separability from the stamper is used and on the other hand, the radiation-curable resin B with high adhesion to the substrate is used and thus two kinds of radiation-curable resins are used for forming a single interlayer to efficiently solve the above-mentioned problem.

### [Method for Manufacturing Multilayer Optical Recording Medium]

The method for manufacturing the multilayer optical recording medium according to the third embodiment will be described.

(a) First, as shown in FIG. 16, a radiation-curable resin A 1000 is dropped on a PC stamper 1001 and the stamper 1001 is rotated to spread the radiation-curable resin A. For example, when a resin with a viscosity of 200 mPa·s is used as the radiation-curable resin A 1000, if the stamper 1001 is spread at 4500 rpm for 5 seconds, a layer with a thickness of about 20 μm can be formed. The PC stamper is the stamper 1001 made of a polycarbonate resin and produced by injection molding using a master stamper just like in a common substrate molding. As the polycarbonate resin, for example, AD5503 or the like manufactured by Teijin Chemicals, Ltd. can be used. Further, it is required to select a resin easy to be separated from the polycarbonate resin as the radiation-curable resin A 1000. For example, those which have high hardness after curing tend to be easily separated from the polycarbonate resin. Herein, an ultraviolet-curable resin is used as the radiation-curable resin A.

Further, the inner diameter R (A) of the position of the stamper 1001 to which the radiation-curable resin A is dropped is determined in a manner that the inner circumferential edge of the completed interlayer becomes a desired radius position (e.g. the position of a diameter of 21 mm) similarly to the first embodiment. Specifically, it is preferable to apply the radiation-curable resin A from a point in the inner circumference side of 23 mm or less in diameter corresponding to the inner circumferential end of the clamp area.

(b) After the radiation-curable resin A is spread in a plane-like state, an ultraviolet lamp is made to irradiate with ultraviolet rays, a radiation beam, to cure the resin. Since the PC stamper 1001 is relatively transparent, curing is possible also by irradiating with a radiation beam through the PC stamper 1001. Further, the ultraviolet lamp may be selected from those used in the first and second embodiments.

(c) At the same time with the application (a) and curing treatment (b) of the radiation-curable resin A in the stamper 1001, a radiation-curable resin B is arranged on a substrate 601 made of polycarbonate. For example, the radiation-curable resin 600 shown in FIG. 12 as the radiation-curable resin B may be dropped on the substrate 601 and spread. As the radiation-curable resin B, DVD-003 used in the above-mentioned the first embodiment (viscosity 450 mPa·s: manufactured by Nippon Kayaku Co., Ltd.) may be used. The substrate 601 is rotated at a rotation speed of 5000 rpm for 30 seconds to obtain a layer of the radiation-curable resin B with a thickness of about 5 μm. Additionally, the UV-PSA sheet 900 shown in FIG. 15 may be used as the radiation-curable resin B. The thicknesses of the radiation-curable resins A and B may be adjusted to give a desired thickness (e.g. 25 μm) to the completed interlayer.

The inner diameter R (B) at the position of the substrate 601 where the radiation-curable resin B is dropped is determined in a manner that the inner circumferential edge of the completed interlayer is at the desired radius position (e.g. at a position of a diameter of 21 mm) similarly to the case of the radiation-curable resin A. Specifically, it is preferable to apply the radiation-curable resin B from a point in the inner circumference side of a diameter of 23 mm or less corresponding to the inner circumferential edge of the clamp area. Further, it is preferable to apply the radiation-curable resins A and B respectively in a manner that the inner diameter R (A) of the radiation-curable resin A applied to the stamper 1001 at the application position and the inner diameter R (B) of the radiation-curable resin B applied to the substrate at the application position satisfy the following relation:

R(B)=<R(A).

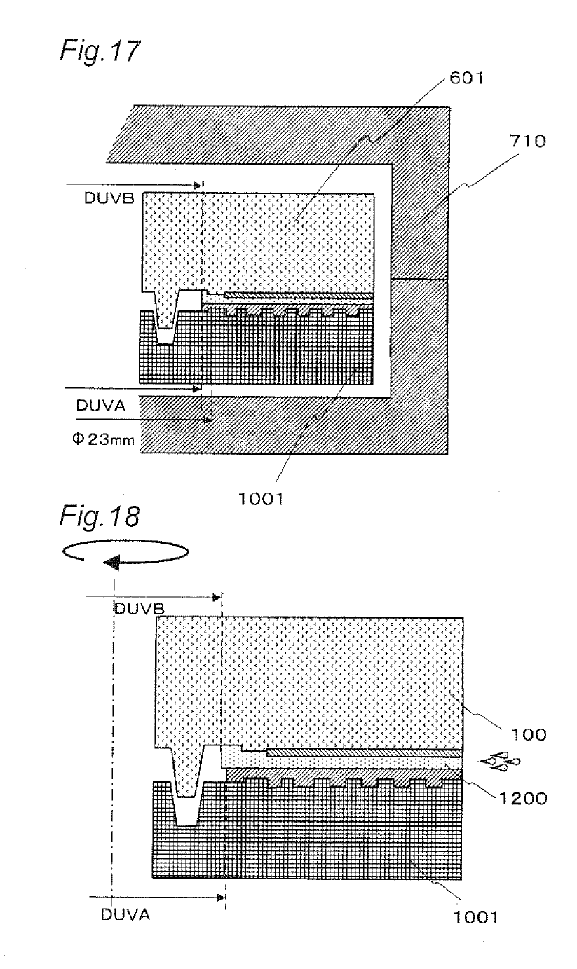

(d) Next, as shown in FIG. 17, a reduced pressure tank 710 is pressure-reduced and the substrate 601 and the PC stamper 1001 are laminated face to face in a manner that the radiation-curable resins A and B are sandwiched between them. If the pressure reduction condition is about 2 kPa, foams to be mixed between the radiation-curable resins A and B can be prevented.

In the above-mentioned case, it is preferable that the inner diameter DUVA of the area where the radiation-curable resin A is formed and the inner diameter DUVB of the area where the radiation-curable resin B is formed are both smaller than a diameter of 23 mm (if possible, smaller than 2.5 mm) and satisfy the relation:

DUVB=<DUVA. Conversely, the inner diameters R (A) and R (B) of the application positions of the radiation-curable resins A and B have to be determined previously for the application in the application steps (a) and (c) of the radiation-curable resins A and B in a manner that the relation DUVB=<DUVA is satisfied. If the respective inner diameters of the radiation-curable resins A and B satisfy the relation DUVB=<DUVA after curing, the radiation-curable resin A 1000 on the PC stamper 1001 is entirely brought into contact with the radiation-curable resin B and therefore the radiation-curable resin A 1000 can be separated entirely from the PC stamper 1001 at the time of separation of the PC stamper 1001. The method for separation and transparent protection layer formation can be carried out by the same methods as in the first and second embodiments and therefore, the explanation is omitted here.

Next, as another example, as shown in FIG. 18 different from the case shown in FIG. 17, a radiation-curable resin B 1200 may be arranged between the substrate 100 to which the radiation-curable resin B is not applied and the PC stamper 1001. In this case, the substrate 100 and the PC stamper 1001 are rotated together to spread the radiation-curable resin B 1200. In this case, it is also preferable that the inner diameters DUVA and DUVB of the respective radiation-curable resins A and B after spreading satisfy the relation DUVB=<DUVA<22.5 mm.

As described above, in the case of using two kinds of radiation-curable resins A and B, it is preferable for the respective inner diameters DUVA and DUVB after curing to satisfy the relation DUVB=<DUVA<22.5 mm. It is preferable to apply the respective radiation-curable resins A and B in a manner that the radiation-curable resins in the nearer side to the substrates 601 and 100 are applied from the sides nearer to the inner diameters. Accordingly, similarly to the first and second embodiments, a multilayer optical recording medium excellent in the flatness in the clamp area of the transparent protection layer formed in the outermost layer can be produced.

Although the PC stamper is used as the stamper in this third embodiment, even in the case of using a stamper of a material different form the material for the substrate, process stability, particularly the separation stability can be improved by using two kinds of radiation-curable resins.

Further, although the liquid type radiation-curable resin A is used in FIG. 16, a UV-PSA sheet easy to be separated from the stamper as shown in FIG. 15 may be used as the radiation-curable resin A. Furthermore, in place of the radiation-curable resin B for sticking the substrate and the radiation-curable resin A, a PSA (pressure sensitive adhesive) having no radiation beam-curability may be used.

At the time of dropping and spreading the radiation-curable resins A and B, same as the explanation in the first and second embodiments, a cap as shown in FIG. 9 may be used and the distribution of the thickness of the radiation-curable resins A and B in the radius direction may be controlled to make the distribution of the thickness of the interlayer also uniform.

Similarly to the first and second embodiments, at the time of forming the transparent protection layer, a film made of plastic may be used.

### Fourth Embodiment

Although optical recording media having two signal recording layers are explained in the first to third embodiments, the optical recording medium may be a multilayer optical recording medium having three or more signal recording layers instead of two layers. Further, the method of any one of the first to third embodiments is employed, so that a multilayer optical recording medium having three or more signal recording layers and excellent in the flatness of the clamp area can be produced. In this fourth embodiment, the configuration of a multilayer optical recording medium having three or more signal recording layers and its manufacturing method will be described.

### [Configuration of Multilayer Optical Recording Medium]

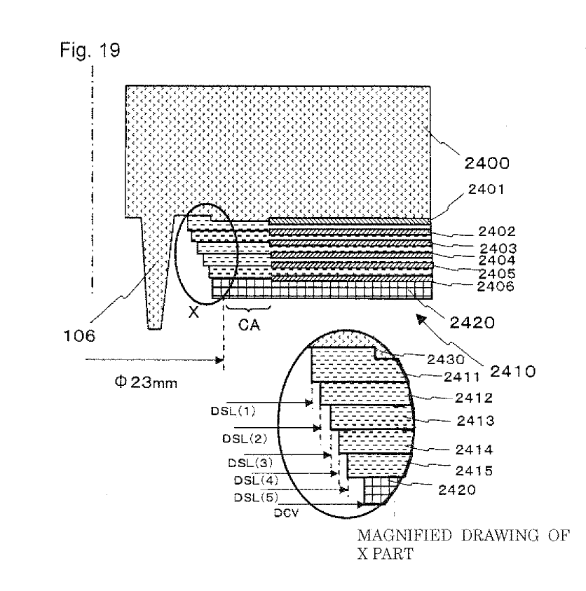

FIG. 19 is a schematic view showing the configuration of a six-layered optical recording medium 2410 having six signal recording layers. There are a sixth signal recording layer 2506, a fifth signal recording layer 2505, a fourth signal recording layer 2504, a third signal recording layer 2503, a second signal recording layer 2502, and a first signal recording layer 2501 (it is formed on a substrate 2400) from the order nearer to a transparent protection layer 2420. With respect to an interlayer between two signal recording layers, for example, the interlayer between the fourth signal recording layer 2504 and the fifth signal recording layer 2505 is a fourth interlayer 2414. That is, the interlayer between the k^{th} signal recording layer and the (k+1)^{th} signal recording layer (in this embodiment, k is 1 or higher and 5 or lower) is the k^{th} interlayer. The transparent protection layer 2420 is formed on a sixth signal recording layer 2406. The region between the outer side than a diameter of 23 mm and the signal recording region of the transparent protection layer 2420 is the clamp area CA. Further, a projection 106 is formed in the circumference of the center hole of the substrate 2400 and the tip end is projected out of the surface of the transparent protection layer 2420. Furthermore, there is a step 2430 at a position of the diameter of 22.1 mm of the substrate 2400 and the height is 20 μm or lower.

Herein, the magnified drawing of an X part shown in FIG. 19 will be described. As being understood from the magnified drawing, if the inner diameters of the regions where a first interlayer 2411, a second interlayer 2412, a third interlayer 2413, a fourth interlayer 2414, a fifth interlayer 2415, and the transparent protection layer 2420 are formed are defined as DSL (1), DSL (2), DSL (3), DSL (4), DSL (5), and DCV, the following relation DSL (1)<DSL (2)<DSL (3)<DSL (4)<DSL (5)<DCV and DCV<23 mm is satisfied. In addition, any inner diameters may be same and DCV is 23 mm or lower as defined as follows: DSL (1)=<DSL (2)=<DSL (3)=<DSL (4)=<DSL (5)=<DCV and DCV=<23 mm.

To generalize the above-mentioned relation, in an optical recording medium having the signal recording layers in a number of n, the relation: DSL (m−1)=<DSL(m) and DSL(n−1)=<DCV for any numeral m (m is 2 or higher and n−1 or less) is satisfied.

If the above-mentioned relation is satisfied, in the case of forming the m^{th} interlayer (m is 2 or higher and n−1 or less), since the (m−1)^{th} interlayer is formed on the entire face to be a base, the edge part of the formation region, particularly the inner circumferential edge, can be coated neatly and the flatness of the clamp area of the m^{th} interlayer can be retained. In addition, the inner circumferential edge of the transparent protection layer 2420 formed on the (n−1)^{th} interlayer can be neatly formed and the flatness of the clamp area of the transparent protection layer 2420 can be maintained. In the first interlayer 2411, since it is to be formed directly on the substrate 2400, it is better that the step 2430 is smaller. As shown in Table 1, the flatness of the first interlayer 2411 can be secured if the size of the step 2430 is 20 μm or smaller.

In this fourth embodiment, the relation of the inner diameters of the interlayers is described, and methods of the above-mentioned first to third embodiments may be employed for producing an optical recording medium.

### [Method for Manufacturing Multilayer Optical Recording Medium]

In the step of applying the radiation-curable resins for forming an interlayer in at least one of the substrate and the stamper, it is preferable to apply the respective radiation-curable resins in a manner that the inner diameter R(k) of the radiation-curable resin to be applied for forming the k^{th} interlayer at the application position and the inner diameter R(k+1) of the radiation-curable resin to be applied for forming the (k+1)^{th} interlayer at the application position satisfy the following relation:

R(k)=<R(k+1).

Further, it is also preferable to apply the radiation-curable resins in a manner that the inner diameter R(n−1) of the radiation-curable resin to be applied for forming the (n−1)^{th} interlayer at the application position and the inner diameter RC of the radiation-curable resin to be applied for forming the transparent protection layer at the application position satisfy the following relation:

R(n−1)=<RC.

Since the thickness of the transparent protection layer and the thickness of the interlayer as well as the optimum values of their thickness precisions differ in accordance with the number of the signal recording layers, it is required to adjust the thickness of the respective layers to be their optimum values.

### Fifth Embodiment

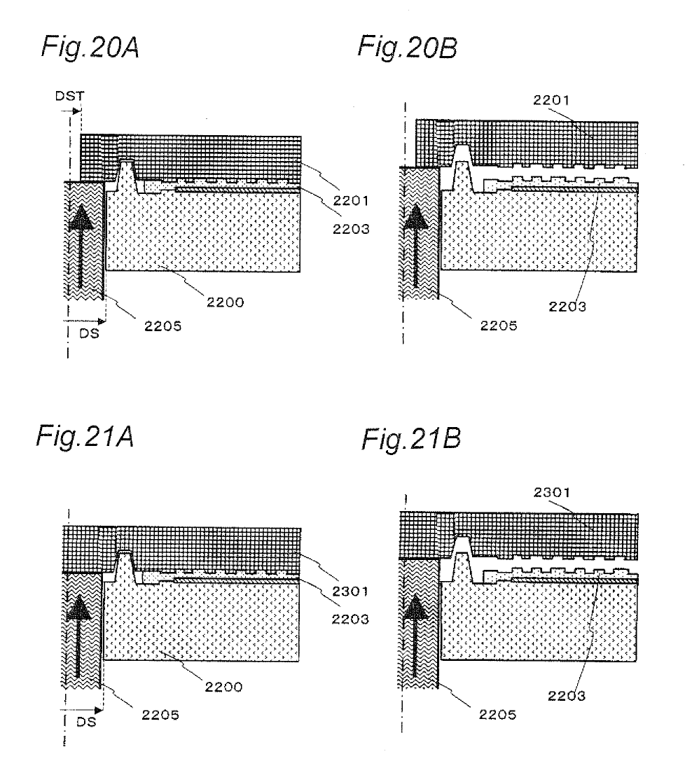

In this fifth embodiment, a method of separating a stamper will be described. Both of FIGS. 20 and 21 show efficient separation methods in the case the center hole of the substrate is made smaller than the center hole of the stamper. This fifth embodiment is characterized in that the center hole of the stamper is made small.

FIG. 20 is a schematic drawing showing the configuration in the case that A diameter DST of the center hole of the stamper is made smaller than A diameter DS of the center hole of the substrate. FIG. 21 is a case that no center hole of the stamper is formed. The periphery of the center hole of the stamper 2201 or the center part of the stamper 2301 is pushed upward by a pusher 2205. In this case, if the substrate 2200 is fixed, the stamper 2201 or 2301 can be separated upward. Further, as an auxiliary, compressed air may be introduced between the interlayer 2203 and the stamper 2201 or 2301 to make the separation easier.

A sandwich structure is produced from an olefin stamper (thickness 0.6 mm) with a center hole of a diameter of 11 mm, a polycarbonate substrate (thickness 1.1 mm) with a center hole of a diameter of 15 mm and bearing an Ag alloy as a signal recording layer, and an ultraviolet-curable resin (DVD 003, manufactured by Nippon Kayaku Co., Ltd.) and the olefin stamper is easily separated by pushing it with a pusher 2205 with an outer diameter of 14.5 mm as shown in FIG. 20.

If this separation method is employed, with no need of using the wedge-like tool as described in the first embodiment, the stamper can stably be separated and since contact with the stamper or the substrate is weaker than the wedge-like tool, the mechanical damage on the stamper or the substrate can be lessened and further, dust generation from the stamper or the substrate can be suppressed.

In the above-mentioned stamper separation method, if the stamper having a smaller center hole than that of the substrate is used, the method can be applicable for the multilayer optical recording medium and their manufacturing method shown in the first to fourth embodiments.

The method for manufacturing a multilayer optical recording medium of the invention is useful for producing an optical information recording medium having a plurality of signal recording layers.

1. A method for manufacturing a multilayer optical recording medium including a plurality of signal recording layers in the signal recording and reading side, an interlayer of a resin layer between two layers of the signal recording layers, and a transparent protection layer with a thickness of 10 μm to 150 μm as an outermost layer, wherein the multilayer optical recording medium has a clamp area corresponding to a region inside of signal recording region, wherein the clamp area ranges in diameter from a diameter of 23 mm to the inner diameter of the signal recording region, the method comprising:
preparing a substrate having the signal recording layers in the main surface side in the signal recording and reading side and projections in a region in the inner side than a diameter of 22 mm, wherein the height difference between the height at a diameter of 23 mm and the height at a diameter of 21 mm is 20 μm or lower;
preparing a stamper;
applying a radiation-curable resin for the interlayer from the inner side than the clamp area of at least one of the substrate and the stamper;
laminating the substrate and the stamper to sandwich the radiation-curable resin between the substrate and the stamper;
curing the radiation-curable resin; and
separating the stamper from the substrate to obtain a radiation-curable resin layer after the curing as the interlayer on the substrate.

2. The method for manufacturing a multilayer optical recording medium according to claim 1, wherein two kinds of radiation-curable resins are used for forming one of the interlayers.

3. The method for manufacturing a multilayer optical recording medium according to claim 2, wherein in the case the two kinds of the radiation-curable resins are defined as radiation-curable resins A and B;
the radiation-curable resin A is applied to the stamper,
the radiation-curable resin B is applied to the substrate,
the stamper and the substrate are laminated with each other in a manner that the radiation-curable resin A and the radiation-curable resin B are sandwiched between them to form a single interlayer by sticking the radiation-curable resin A and the radiation-curable resin B.

4. The method for manufacturing a multilayer optical recording medium according to claim 3, wherein the radiation-curable resins A and B are applied in a manner that the inner diameter R (A) of the radiation-curable resin A applied to the stamper at the application position and the inner diameter R (B) of the radiation-curable resin B applied to the substrate at the application position satisfy the following relation:
R(B)=<R(A).

5. The method for manufacturing a multilayer optical recording medium according to claim 4, wherein the multilayer optical recording medium to be obtained satisfies the relation of the inner diameter DUVA of the area where the radiation-curable resin A is formed and the inner diameter DUVB of the area where the radiation-curable resin B is formed of DUVB=<DUVA.

6. The method for manufacturing a multilayer optical recording medium according to claim 1, wherein in a case the multilayer optical recording medium includes a plurality of signal recording layers and a plurality of interlayers wherein there are n (n is 2 or higher) in number of signal recording layers arranged from the first signal recording layer, . . . the (n−1)^{th} signal recording layer, to the n^{th} signal recording layer from the substrate side toward the transparent protection layer as the outermost layer, and an interlayer existing between the k^{th} (k is 1 or higher and (n−1) or lower) signal recording layer and the (k+1)^{th} signal recording layer is defined as the k^{th} interlayer and
in the step of applying the radiation-curable resins for forming the interlayer in at least one of the substrate and the stamper,
the respective radiation-curable resins are applied in a manner that the inner diameter R (k) of the radiation-curable resin to be applied for forming the k^{th} interlayer at the application position and the inner diameter R (k+1) of the radiation-curable resin to be applied for forming the (k+1)^{th} interlayer at the application position satisfy the following relation:
R(k)=<R(k+1).

7. The method for manufacturing a multilayer optical recording medium according to claim 6, wherein the radiation-curable resins are applied in a manner that the inner diameter R(n−1) of the radiation-curable resin to be applied for forming the (n−1)^{th} interlayer at the application position and the inner diameter RC of the radiation-curable resin to be applied for forming the transparent protection layer at the application position satisfy the following relation:
R(n−1)=<RC.

8. The method for manufacturing a multilayer optical recording medium according to claim 7, wherein in the case the diameter of the inner circumferential edge of a region where the k^{th} interlayer is formed is defined as DSL (k) and the diameter of the inner circumferential edge of a region where the transparent protection layer is formed is defined as DCV, the multilayer optical recording medium to be obtained satisfies the following relation:
DSL(m−1)=<DSL (m) wherein m (m is 2 or higher and n−1 or lower) denotes an arbitrary number and
DSL(n−1)=<DSV.

9. The method for manufacturing a multilayer optical recording medium according to claim 4, further comprising:
curing the radiation-curable resin A or B by irradiating with a radiation beam, wherein radiation beam irradiation is carried out with the intensity distribution of the radiation beam to be irradiated to the inner side region than the inner diameter of the signal recording region in the radius direction.

10. The method for manufacturing a multilayer optical recording medium according to claim 9, wherein at the time of curing the radiation-curable resin A or B, the radiation beam irradiation is carried out with a lowered intensity of the radiation beam irradiated to the signal recording region to make the curing degree lower in the inner side region than the inner diameter of the signal recording region in the radius direction than that in the signal recording region.

11. The method for manufacturing a multilayer optical recording medium according to claim 9, wherein at the time of curing the radiation-curable resin A or B, the intensity of the radiation beam irradiated to the inner side region than the inner diameter of the signal recording region in the radius direction is lowered to 35% to 85% of the irradiation intensity of the radiation beam in the signal recording region.

12. The method for manufacturing a multilayer optical recording medium according to claim 1, wherein the projections in the substrate are projected out of the surface of the transparent protection layer of the outermost layer layered on the substrate.

13. The method for manufacturing a multilayer optical recording medium according to claim 1, wherein in the case the stamper is laminated face to face on the substrate, the stamper has depression-like projection escapes for escaping from the projections at the positions corresponding to the projections of the substrate.

14. The method for manufacturing a multilayer optical recording medium according to claim 1, further comprising:
spreading the radiation-curable resin by spinning the substrate and the stamper after laminating the substrate and the stamper.

15. The method for manufacturing a multilayer optical recording medium according to claim 1, further comprising:
spreading the radiation-curable resin by spinning at least one of the substrate and the stamper.

16. The method for manufacturing a multilayer optical recording medium according to claim 1, wherein the interlayer is formed from the inner side of a diameter of 22.5 mm.

17. The method for manufacturing a multilayer optical recording medium according to claim 2, wherein in the case of using radiation-curable resins A and B for the two kinds of the radiation-curable resins, the method further comprising:
(a) dropping and spreading the radiation-curable resin A on the stamper in a plane-like state on the stamper and thereafter curing the radiation-curable resin A by irradiating with a radiation beam;
(b) arranging the radiation-curable resin B between the stamper and the substrate and spreading the radiation-curable resin B by spinning the substrate and the stamper together; and
(c) curing the radiation-curable resin B by irradiating with a radiation beam.

18. The method for manufacturing a multilayer optical recording medium according to claim 2, wherein in the case of using radiation-curable resins A and B for the two kinds of the radiation-curable resins, the method further comprising:
(a) dropping and spreading the radiation-curable resin B on the stamper in a plane-like state on the substrate and thereafter curing the radiation-curable resin B by irradiating with a radiation beam;
(b) arranging the radiation-curable resin A between the stamper and the substrate and spreading the radiation-curable resin A by spinning the substrate and the stamper together; and
(c) curing the radiation-curable resin A by irradiating with a radiation beam.

19. The method for manufacturing a multilayer optical recording medium according to claim 2, wherein in the case of using radiation-curable resins A and B for the two kinds of the radiation-curable resins, the method further comprising:
(a) dropping and spreading the radiation-curable resin A on the stamper in a plane-like state on the stamper and thereafter curing the radiation-curable resin A by irradiating with a radiation beam;
(b) dropping the radiation-curable resin B on the substrate and spreading the radiation-curable resin B by spinning the substrate; and
(c) laminating the substrate and the stamper in a manner that the radiation-curable resins A and B are sandwiched between them under reduced pressure and thereafter curing the radiation-curable resin B by irradiating with a radiation beam.

20. The method for manufacturing a multilayer optical recording medium according to claim 2, wherein in the case of using radiation-curable resins A and B for the two kinds of the radiation-curable resins, the method further comprising:
(a) dropping and spreading the radiation-curable resin B on the substrate in a plane-like state on the substrate and thereafter curing the radiation-curable resin B by irradiating with a radiation beam;
(b) dropping the radiation-curable resin A on the stamper and spreading the radiation-curable resin A by spinning the stamper; and
(c) laminating the substrate and the stamper in a manner that the radiation-curable resins A and B are sandwiched between them under reduced pressure and thereafter curing the radiation-curable resin A by irradiating with a radiation beam.

21. The method for manufacturing the multilayer optical recording medium according to claim 1, further comprising:
dropping a radiation-curable resin for forming the transparent protection layer on a cap in the case of using the cap for clogging the center hole of the substrate;
spreading the radiation-curable resin by spinning the substrate; and
curing the radiation-curable resin by irradiating with a radiation beam to form the transparent protection layer after removing the cap, wherein the diameter of the cap is wider than the inner diameter of the region where the interlayer is formed and has a diameter of 24 mm or less and.

22. The method for manufacturing the multilayer optical recording medium according to claim 1, wherein the diameter of the center hole of the stamper is smaller than the diameter of the center hole of the substrate and in the step of separating the stamper from the substrate, the stamper is separated by applying stress to the peripheries of the center hole of the stamper in the inner side than the center hole of the substrate in the direction opposed to the side where the substrate exists.

23. The method for manufacturing the multilayer optical recording medium according to claim 22, wherein the stamper has no center hole.
